(19) United States
(12) Patent Application Publication
(10) Pub. No.: US 2023/0171761 A1
(43) Pub. Date: Jun. 1, 2023

(54) Pre-Emption Management in Sidelink Transmission Systems

(71) Applicant: JRD COMMUNICATION (SHENZHEN) LTD., Shenzhen, Guangdong (CN)

(72) Inventor: Umer Salim, Shenzhen, Guangdong (CN)

(73) Assignee: JRD COMMUNICATION (SHENZHEN) LTD., Shenzhen, Guangdong (CN)

(21) Appl. No.: 17/905,619

(22) PCT Filed: Feb. 5, 2021
(86) PCT No.: PCT/CN2021/075628

§ 371 Date: Sep. 2, 2022

Related U.S. Application Data
(60) Provisional application No. 62/971,133, filed on Feb. 6, 2020.

(51) Int. Cl. H04W 72/1263; H04W 72/563; H04W 72/54; H04W 72/25

(52) U.S. Cl. CPC H04W 72/1263; H04W 72/563; H04W 72/54; H04W 72/25

(57) ABSTRACT

Methods to improve reselection of resources following pre-emption of reserved resources for sidelink communications. Reselection may be performed using an adjusted priority to reduce the prospects of the reselected transmission also being pre-empted. Alternatively the threshold used to decide whether resources have been pre-empted is adjusted if the resources are reselected rather than an initial selection.

### TECHNICAL FIELD

The following disclosure relates to management of pre-emption for sidelink transmissions in cellular networks.

### BACKGROUND

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards a broadband and mobile system.

In cellular wireless communication systems User Equipment (UE) is connected by a wireless link to a Radio Access Network (RAN). The RAN comprises a set of base stations which provide wireless links to the UEs located in cells covered by the base station, and an interface to a Core Network (CN) which provides overall network control. As will be appreciated the RAN and CN each conduct respective functions in relation to the overall network. For convenience the term cellular network will be used to refer to the combined RAN & CN, and it will be understood that the term is used to refer to the respective system for performing the disclosed function.

The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB. NR is proposed to utilise an Orthogonal Frequency Division Multiplexed (OFDM) physical transmission format.

NR has added a lot of capabilities and technical features to the wireless strategies going way beyond LTE for operation on licensed spectrum. In addition, the NR protocols are intended to offer options for operating in unlicensed radio bands, to be known as NR-U. When operating in an unlicensed radio band the gNB and UE must compete with other devices for physical medium/resource access. For example, Wi-Fi, NR-U, and LAA may utilise the same physical resources.

A trend in wireless communications is towards the provision of lower latency and higher reliability services. For example, NR is intended to support Ultra-reliable and low-latency communications (URLLC) and massive Machine-Type Communications (mMTC) are intended to provide low latency and high reliability for small packet sizes (typically 32 bytes). A user-plane latency of 1 ms has been proposed with a reliability of 99.99999%, and at the physical layer a packet loss rate of 10⁻⁵ or 10⁻⁶ has been proposed.

mMTC services are intended to support a large number of devices over a long life-time with highly energy efficient communication channels, where transmission of data to and from each device occurs sporadically and infrequently. For example, a cell may be expected to support many thousands of devices.

The disclosure below relates to various improvements to cellular wireless communications systems.

### SUMMARY

There is provided a method of scheduling sidelink transmissions between mobile stations in a cellular communications network, the method comprising the steps of at a first mobile station transmitting a first reservation with a first priority for first reserved transmission resources; at the first mobile station detecting a second reservation by a second mobile station for second reserved transmission resources which overlap with the first reserved transmission resources; at the first mobile station measuring the RSRP of the second reservation; at the first mobile station comparing the measured RSRP to a first predefined threshold; and if the measured RSRP is greater than the first predefined threshold, at the first mobile station considering the first reserved transmission resources as pre-empted, cancelling the transmission on the first reserved transmission resources, and initiating re-selection of transmission resources to replace the first reserved transmission resources using a second priority which is higher than the first priority.

The re-selected transmission resources may be pre-empted, at the first mobile station performing a further re-selection with a priority that is higher than the second priority.

The priority may be increased by the same amount at each re-selection.

The priority may be increased by a different amount at each re-selection.

The method may further comprise at a third mobile station receiving a transmission on the re-selected transmission resources with an increased priority, and reducing that increased priority to the original value.

The increase in priority may be dependent on the mobile station's configuration.

The increase in priority may be dependent on the resource pool of the transmission resources.

The priority of the second reservation may be higher than the first priority.

There is also provided a method of scheduling sidelink transmissions between mobile stations in a cellular communications network, the method comprising the steps of at a first mobile station transmitting a first reservation with a first priority for first reserved transmission resources; at the first mobile station detecting a second reservation by a second mobile station for second reserved transmission resources which overlap with the first reserved transmission resources; at the first mobile station measuring the RSRP of the second reservation; at the first mobile station comparing the measured RSRP for the second reservation to a threshold, wherein the threshold is dependent on whether the first reservation is a new reservation or a re-selection following pre-emption of a previous reservation; and if the measured RSRP is greater than the threshold, at the first mobile station considering the first reserved transmission resources as pre-empted, cancelling the transmission on the first reserved transmission resources, and initiating re-selection of transmission resources to replace the first reserved transmission resources using the same priority as the first reservation.

The threshold may be dependent on the number of times the planned transmission has re-selected.

The threshold may be increased by the same amount for each previous re-selection.

The threshold may be increased by a different amount for each previous re-selection.

The priority of the second reservation may be higher than the first priority.

The threshold may be dependent on a configuration of the mobile station.

The threshold may be dependent on a configuration of the resource pool of the reserved transmission resources.

There is also provided a method of scheduling sidelink transmissions between mobile stations in a cellular communications network, the method comprising the steps of at a first mobile station transmitting a first reservation with a first priority for first reserved transmission resources; at the first mobile station detecting a second reservation by a second mobile station for second reserved transmission resources which overlap with the first reserved transmission resources; at the first mobile station measuring the RSRP for the second reservation; at the first mobile station comparing the measured RSRP for the second reservation to a threshold, and at the first mobile station transmitting on the first reserved transmission resources, wherein the transmission power is reduced dependent on the comparison of the measured RSRP to the threshold.

The transmission power may be reduced by the difference between the threshold and the measured RSRP.

The transmission power may be reduced based on the difference between the threshold and the measured RSRP.

The reduction may be dependent on a configuration of the mobile station.

The reduction may be dependent on a configuration of the resource pool of the reserved transmission resources.

The threshold may be dependent on whether the first reservation is a new reservation or a re-selection.

The priority of the second reservation may be higher than the first priority.

The reduction may be applied for all of the first reserved transmission resources.

When the transmission power is reduced other transmission parameters may be modified for transmissions on the first reserved transmission resources.

The modulation coding scheme may be adjusted, the code rate may be increased, or a higher aggregation level may be utilised.

The modulation format of a second stage SCI transmitted in the first reserved transmission resources may be adjusted when the transmission power is reduced.

The position of reference symbols in the transmission on the first reserved transmission resources may be adjusted to avoid a collision with reference symbols in the second reserved transmission resources.

The position of a sidelink control information element in the transmission on the first reserved transmission resources may be adjusted to avoid a collision with a sidelink control information element SCI in the second reserved transmission resources.

If the difference between the measured RSRP and the threshold is greater than a second threshold, the method may comprise cancelling the first reservation and performing a re-selection.

The transmission power on the first reserved transmission resources may be increased if the priority of the second reservation is lower than the first priority.

There is also provided a method of scheduling sidelink transmissions between mobile stations in a cellular communications network, the method comprising the steps of at a first mobile station transmitting a first reservation with a first priority for first reserved transmission resources; at the first mobile station detecting a second reservation by a second mobile station for second reserved transmission resources which overlap with the first reserved transmission resources, wherein the second reservation has second priority which is no higher than the first priority; at the first mobile station measuring the RSRP of the second reservation; at the first mobile station comparing the measured RSRP to a first predefined threshold; and if the measured RSRP is greater than the first predefined threshold increasing the transmission power a transmission on the first reserved transmission resources.

The transmission power may be increased by a predefined amount.

The transmission power may be increased by an amount dependent on the difference between the measured RSRP and the predefined threshold.

The increase in transmission power may be dependent on the configuration for the resource pool used for the transmission.

The increase in transmission power may be only applied in the overlapping portion of the first transmission resources.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 shows selected elements of a cellular wireless communication network;

FIG. 2 shows selected elements in a Radio Area Network of the cellular wireless communication network of FIG. 1;

FIG. 3 shows a method of pre-emption;

FIG. 4 shows a method of adjusting priority due to pre-emption;

FIG. 5 shows a method of adjusting an RSRP threshold due to pre-emption;

FIG. 6 shows a method of transmitting at a reduced power on overlapping resources;

FIG. 7 shows a method of adjusting transmission based on multiple thresholds; and

FIG. 8 shows a method of increasing the transmission power of a higher priority transmission.

### DETAILED DESCRIPTION OF THE PREFERRED EMBODIMENTS

Those skilled in the art will recognise and appreciate that the specifics of the examples described are merely illustrative of some embodiments and that the teachings set forth herein are applicable in a variety of alternative settings.

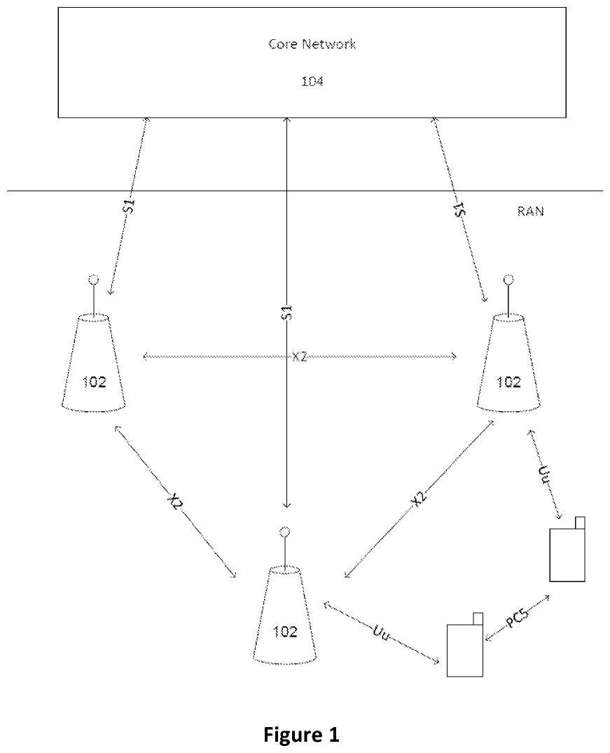

FIG. 1 shows a schematic diagram of three base stations 102 (for example, eNB or gNBs depending on the particular cellular standard and terminology) forming a cellular network. Typically, each of the base stations 102 will be deployed by one cellular network operator to provide geographic coverage for UEs in the area. The base stations form a Radio Area Network (RAN). Each base station 102 provides wireless coverage for UEs in its area or cell. The base stations 102 are interconnected via the X2 interface and are connected to a core network 104 via the S1 interface. As will be appreciated only basic details are shown for the purposes of exemplifying the key features of a cellular network. The interface and component names mentioned in relation to FIG. 1 are used for example only and different systems, operating to the same principles, may use different nomenclature.

The base stations 102 each comprise hardware and software to implement the RAN's functionality, including communications with the core network 104 and other base stations 102, carriage of control and data signals between the core network and UEs, and maintaining wireless communications with UEs associated with each base station. The core network 104 comprises hardware and software to implement the network functionality, such as overall network management and control, and routing of calls and data.

In vehicle-to-vehicle (V2V) applications, the UEs may be incorporated into vehicles such as cars, trucks and buses. These vehicular UEs are capable of communicating with each other in in-coverage mode, where a base station manages and allocates the resources and in out-of-coverage mode, without any base station managing and allocating the resources. In vehicle-to-everything (V2X) applications, the vehicles may be communicating not only with other vehicles, but also with infrastructure, pedestrians, cellular networks and potentially other surrounding devices. V2X use cases include:

1) Vehicles Platooning—this enables the vehicles to dynamically form a platoon travelling together. All the vehicles in the platoon obtain information from the leading vehicle to manage this platoon. This information allows the vehicles to drive closer than normal in a coordinated manner, going to the same direction and travelling together.

2) Extended Sensors—this enables the exchange of raw or processed data gathered through local sensors or live video images among vehicles, road site units, devices of pedestrian and V2X application servers. The vehicles can increase the perception of their environment beyond of what their own sensors can detect and have a more broad and holistic view of the local situation. High data rate is one of the key characteristics.

3) Advanced Driving—this enables semi-automated or full-automated driving. Each vehicle and/or RSU shares its own perception data obtained from its local sensors with vehicles in proximity and that allows vehicles to synchronize and coordinate their trajectories or manoeuvres. Each vehicle shares its driving intention with vehicles in proximity too.

4) Remote Driving—this enables a remote driver or a V2X application to operate a remote vehicle for those passengers who cannot drive by themselves or remote vehicles located in dangerous environments. For a case where variation is limited and routes are predictable, such as public transportation, driving based on cloud computing can be used. High reliability and low latency are the main requirements.

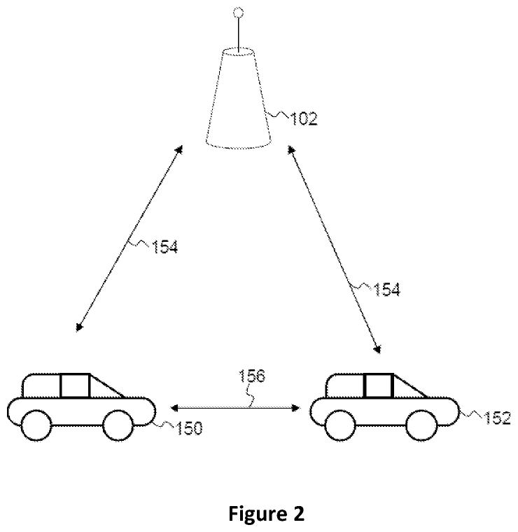

FIG. 2 illustrates a base station 102 forming a RAN, and a sidelink transmitter (SL Tx UE) UE 150 and a sidelink receiver (SL Rx UE) UE 152 in the RAN. UEs 150 and 152 are described as transmitter and receiver only for the purposes of explanation during a particular communication, and their roles may equally be reversed. The base station 102 is arranged to wirelessly communicate over respective connections 154 with each of the SL Tx UE 150 and the SL Rx UE 152. The SL Tx UE 150 and the SL Rx UE 152 are arranged to wirelessly communicate with each other over a sidelink 156.

Sidelink transmissions utilise TDD (half duplex) on either a dedicated carrier, or a shared carrier with conventional Uu transmissions between a base station and UE. Resource pools of transmission resources are utilised to manage resource and allocation and manage interference between potentially concurrent transmissions. A resource pool is a set of time-frequency resources from which resources for a transmission can be selected. UEs can be configured with multiple transmit and receive resource pools.

Two modes of operation are used for resource allocation for sidelink communication depending on whether the UEs are within coverage of a cellular network. In Mode 1, the V2X communication is operating in-coverage of the base stations (eg eNBs or gNBs). All the scheduling and the resource assignments may be made by the base stations.

Mode 2 applies when the V2X services operate out-of-coverage of cellular base stations. Here the UEs need to schedule themselves. For fair utilization, sensing-based resource allocation is generally adopted at the UEs. In Mode 2, UEs reserve resources for a transmission by transmitting a Sidelink Control Information (SCI) message indicating the resources to be used. The SCI notifies the recipient (which may be a single UE in unicast, a group of UEs in groupcast, or all reachable UEs in broadcast) of the details of the transmission it can expect.

The following disclosure relates principally to UEs operating in Mode 2, but aspects may be applicable to operation in Mode 1 as well.

Sidelink transmissions may be allocated different priority levels depending on the QoS requirements of the service for which data is being transmitted. Pre-emption may be permitted for sidelink transmissions such that a higher-priority, but later occurring, transmission requirement can pre-empt an earlier, lower priority, reservation for transmission resources. That is, a UE can utilise already-reserved resources for its transmission if the priority of the relevant transmission is higher. The UE whose planned transmission is pre-empted performs a new selection process to identify and reserve new resources for the transmission. Although this mechanism permits prioritisation of traffic, difficulties can occur for lower-priority traffic. The following disclosure provides various approaches to improving pre-emption and resource sharing techniques for sidelink systems operating in Mode 2. The transmission resources initially allocated for the first UE, and then pre-empted, can be said to be overlapping as the selections by the two UEs overlap.

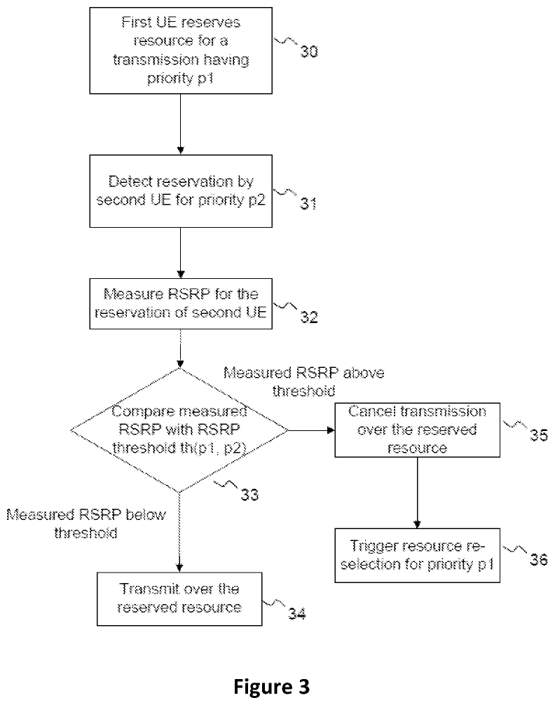

FIG. 3 shows an example difficulty with sidelink pre-emption. At step 30 a first UE reserves resources for a future transmission with a first priority p₁. At step 31, subsequent to the reservation of step 30 but prior to the actual transmission, the first UE detects a reservation by a second UE for resources which overlap with those reserved at step 30. The second UE's reservation has a second, higher, priority p₂ than the first priority. The first UE, at step 32, measures the RSRP of the second UE's reservation message, and if it is below a pre-configured SL RSRP threshold at step 33, continues with its transmission at step 34. This threshold is a function of the first priority p₁ and the second priority p₂ and can be denoted as th(p₁, p₂) However, if the measured RSRP is above the SL RSRP threshold th(p₁, p₂) the UE cancels its planned transmission at step 35 and triggers resource re-selection for priority p₁ at step 36. This resource selection may involve reservation of resources as in step 30. The first UE may then, again, detect a pre-emption of the reserved resources and transmission may again be delayed. In heavy traffic situations where transmission resources are limited a particular TB may be deleted multiple times leading to QoS degradation.

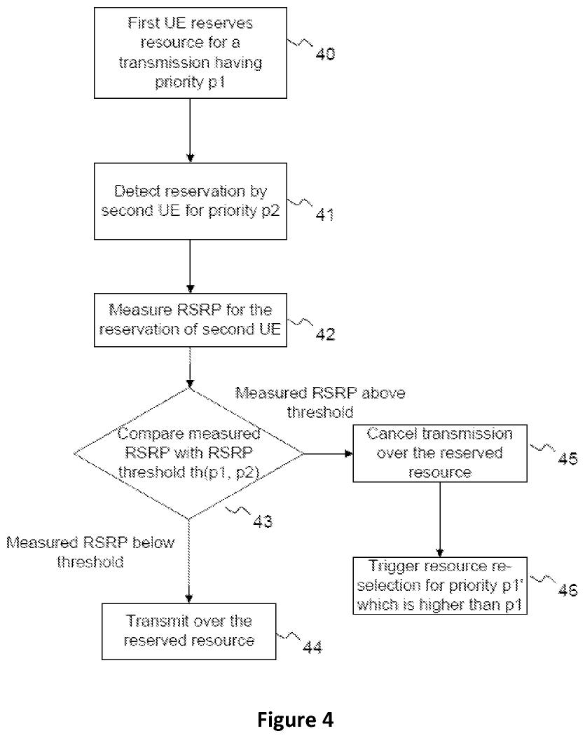

In a first approach, shown in FIG. 4, a method is intended to reduce multiple pre-emptions of a particular Transport Block (TB), thereby improving QoS compared to a lower priority transmission which is pre-empted a number of times.

Steps 40-45 correspond to steps 30-35 of FIG. 3 and hence will not be described in detail again. However, in the method of FIG. 4, after a first pre-emption of a planned transmission, the resource reselection at step 46 is performed for a priority p1′ which is higher than p1. This reduces the probability that the transmission is again pre-empted. In the event that the transmission is pre-empted again, the priority level may be increased further before another reselection process.

The priority level may be increased by one level each time, or larger increases may be utilised in order to provide a desired reduction in multiple pre-emptions. The larger the increase in priority the lower the likelihood of a second pre-emption, but this may increase the prospect of genuinely high priority traffic being delayed. The priority change may be pre-configured to follow a certain pattern from one pre-emption to the next.

The receiver UE for the (initially) lower priority transmission will be aware that the first attempt was pre-empted and can hence infer that the priority of a later successful transmission was thus increased. Accordingly, when the UE does receive the transmission it ascertains the priority indication from the relevant SCI and reduces its level to return it to the original value prior to passing the information to the higher layers. Alternatively, the higher layers at the RX may update the priority as appropriate by getting the information for a certain transmission between a given transmitter, receiver, HARQ process number etc.

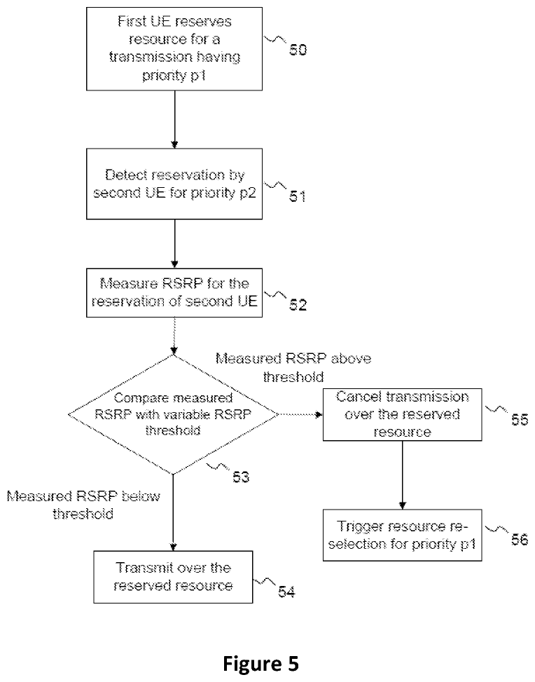

FIG. 5 shows a further approach to avoiding multiple pre-emptions of a particular TB. The steps correspond to those of FIG. 4, except at step 53 the measured RSRP is compared with a variable SL RSRP threshold. In particular, at the first transmission attempt the standard threshold value is used. However, if the first attempt is pre-empted and cancelled, on the second attempt the threshold is increased by a pre-defined amount, thereby reducing the probability that the transmission will be cancelled again because the SL RSRP of the later UE (with a higher priority) must be higher in order for the first UE not to transmit. The advantage of this scheme is that no priority adjustment is required at the RX and hence no possibility of mis-alignment for the priority of a given transmission between a sidelink TX and RX.

In an example the SL RSRP threshold may be increased by a single predefined value, for example 3 dB. In a further example a sequence of increases (which may be the same or variable) may be defined such that the value is progressively increased each time there is a pre-emption until the TB is successfully transmitted. Increasing the threshold increases the probability that a later transmission will be made but does not affect the chances of successful reception decoding at the receiver.

In a different example, if the SL RSRP threshold for the first transmission was th(p₁, p₂), where th is the RSRP threshold for own priority p₁ and the other UE reservation with priority p₂. If this reservation gets pre-empted, the user does the re-selection of resources with its priority p₁, but if it detects again a higher priority transmission with priority p₂, it uses the threshold considering own priority p₁′, which is one level higher in priority than p₁. Then it uses the threshold th(p₁′, p₂) instead of th(p₁, p₂).

The techniques of FIGS. 4 and 5 thus provide methods which seek to reduce the number of times the resources for transmission of a transport block are pre-empted.

As explained with reference to FIG. 3 a UE's reserved transmission resources may be pre-empted, and a transmission prevented, if the RSRP measurement of the higher-priority reservation is higher than a pre-defined threshold. That is, the measured SL-RSRP of the higher priority transmission must be larger than a threshold for pre-emption to occur. In order to avoid the complete cancellation of the lower-priority transmission (and subsequent reselection of new resources) the lower priority transmission may proceed on the overlapping resources as planned, but with a reduced transmission power. That is both transmissions proceed using the same transmission resources. The power reduction for the lower priority transmission reduces the likelihood of interference with the higher priority transmission, but is intended to be sufficient to allow successful reception of the lower priority transmission despite the sharing of transmission resources.

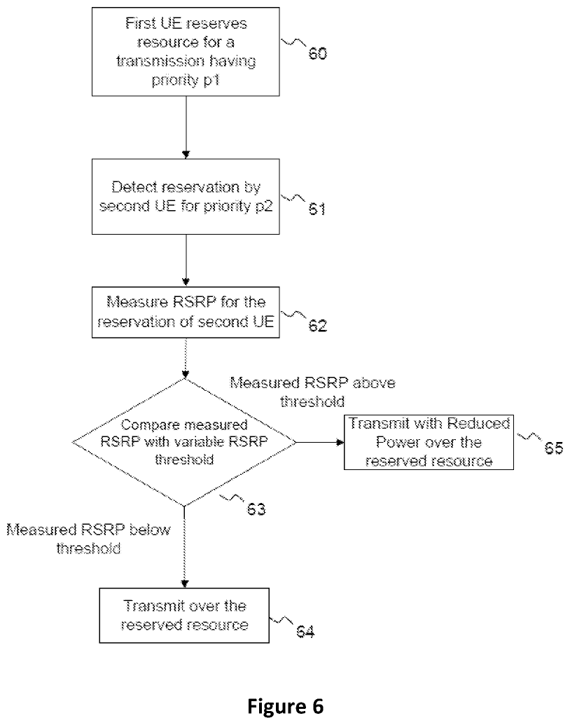

FIG. 6 shows an example of a method permitting transmission by both UEs on the same transmission resources. Steps 60-64 correspond to the previous figures and are therefore not described in detail. At step 65, rather than cancel the currently planned transmission the transmission proceeds on the originally reserved resources but at a lower transmission power.

In an example, the transmission power of the lower priority transmission is calculated based on the SL-RSRP measured for the higher priority transmission and the associated SL-RSRP threshold. For example the power may be reduced as shown in the following equation:

Power_reduction_factor=Estimated_RSRP−SL_RSRP_Threshold

This reduction is selected as it represents the amount by which measured SL RSRP for the higher priority transmission is larger than the threshold. This means that this is the surplus power from the higher priority transmission. As channel variations are the same in both directions, ignoring the transmit/receive electronic difference at the devices, the proposition to reduce the transmit power of the lower priority transmission by the same factor (Estimated_RSRP−SL_RSRP_Threshold) becomes optimal as it allows the operation with two simultaneous transmissions at peak power point where it is allowed. To be precise, the detection quality for the higher priority transmission depends upon the signal and interference power from the lower priority transmission at the receiver of the higher priority transmission, but that is not in general known at the SL TX UE for the lower priority transmission, and it would have transmitted if the estimated (for the avoidance of doubt, the terms estimated and measured RSRP may be used interchangeably) RSRP associated to the higher priority SL transmission was equal to the SL RSRP threshold. The transmission power for the lower priority transmission is then given by:

Updated_Transmit_power=Transmit_power−Power_reduction_factor

Where “Transmit_power” is the original planned transmission power for the lower priority transmission prior to the UE being aware of the higher priority transmission. The updated transmission power may be rounded off, for example by applying a ceiling or flooring operation as required to give a transmission power for the lower priority transmission on the overlapping transmission resources.

In a further example, the lower priority transmission power may be reduced by one, or a series of, predefined values. The values may defined and configured to each user, or set during pre-configuration. Furthermore the power reduction value can be part of the resource pool configuration. In an example, the power may be reduced by 3 dB compared to the power initially selected for the transmission.

As opposed to a single value for power reduction, multiple options may be defined. An actual value may be selected from the options based on predefined parameters. In an example the value is selected based on the difference between the estimated RSRP of the higher priority transmission for the overlapping resources and the relevant SL RSRP threshold. The following table shows an example using these parameters:

| Power | D = Estimated RSRP of |
|---|---|
| Reduction | overlapping resource − SL |
| Factor | RSRP Threshold |
| (dB) | (dB) |
| A1 | 0 < D ≤ b1 |
| A2 | b1 < D ≤ b2 |
| A3 | b2 < D ≤ b3 |
| A4 | b3 < D |

Suitable power reduction values A1, A2 etc can be selected for each range of D as appropriate for a particular system. In an example, A1=b1=3 dB, A2=b2=6 dB, A3=b3=9 dB and A4=12 dB.

One such table can be defined for all UEs and pre-configured to the UEs, or tables can be configured during resource pool configuration to provide more flexibility. The latter approach allows the power reduction and ranges to be configured to the specific characteristics of each resource pool and which can be reconfigured by the network as necessary.

In summary, when a UE's transmission is pre-empted by another UE with a higher priority transmission and a measured SL-RSRP above the threshold the UE with the lower priority transmits on the overlapping resources with a reduced transmission power. The power reduction may be a fixed value or derived from a table which may be based on the difference between the SL-RSRP measurement associated with the resource and a relevant SL-RSRP threshold.

It is possible that only some of the transmission resources overlap in which case the reduced transmission may be used for all symbols, even those that do not overlap. Although the original transmission power could be used for the non-overlapping symbols the change in transmission power may create transitions at the Tx and further result in decoding difficulties at the RX.

In order to offset the effect of reducing the transmission power for the lower priority transmission other transmission parameters may be modified. For example, the code rate used for the first stage SCI may be increased (compared to the code rate that would have been used prior to becoming aware of the overlapping transmission). This may be achieved by using a higher aggregation level such that the 1^{st} stage SCI is transmitted over a greater number of PRBs. Available PRBs are defined by resource pool configurations, including rules for the PRBs to be used for 1^{st} stage SCI transmissions. Those configurations may include additional aggregation levels where transmission power may be reduced for overlapping transmissions as discussed above.

Interference between the overlapping transmissions may also be mitigated (at least partially) by using different frequency positions for the reference symbol resource elements in the 1^{st} stage SCI of each overlapping transmissions (which are transmitted on the PSCCH). Similarly, the position of the 1^{st} stage SCI in the allocated PRBs may be modified for one of the overlapping transmissions. In standard operation the 1^{st} stage SCI is aligned with the lowest sub-channel index in the allocation, but this may be modified such that for selected transmissions the 1^{st} stage SCI may be displaced and positioned on a different sub-channel, for example the highest index sub-channel. For example, the 1^{st} stage SCI of the lower priority transmission may be positioned in the highest index sub-channel, and the 1^{st} stage SCI of the higher priority transmission may be positioned in the lowest index sub-channel. For a transmission spanning more than one sub-channel, this allows non-overlapping PSCCH (1^{st} stage SCI and its dedicated DMRS), which is expected to improve detection probability for the 1^{st} stage SCI and improve the performance of the receivers of both transmissions.

The transmission parameters of the 2^{nd} stage SCI may also be modified in view of a reduced transmission power. For example, typically a QPSK modulation format is used for the 2^{nd} stage SCI but this could be changed to provide a different coding rate, or a different aggregation level could be utilised. The 2^{nd} stage SCI format is indicated in the 1^{st} stage SCI, for example in the “information on amount of resources for 2^{nd} SCI” field”, e.g. beta offset indicator (see TS38.212, 8.3.1.1) or aggregation indicator. Additional options for the beta offset indicator may be required to achieve an acceptable reliability at the reduced transmission power.

In summary, when transmitting a lower priority transmission at a lowered transmission power the MCS for the transmission may be adjusted compensate, at least partly, for the reduced power. The adjustment of MCS will typically lead to a larger transmission resource requirement, but the available resources were reserved based on the higher power (and lower code rate) and hence may not be sufficient for the full transmission at the lower power. The transmitting UE may therefore puncture the transmission using a rate matching procedure to fit the transport block at the higher MCS into the reserved resources. Although this may reduced the decoding probability it is better than making no transmission and the received transmissions may be useful for decoding in conjunction with a later retransmission.

Where two transmitters are scheduled to transmit on overlapping resources (due to pre-emption of an earlier lower priority reservation with a later higher priority reservation) as discussed above the lower transmission should be cancelled or made at a lower power to avoid interference with the higher priority transmission. However, since neither transmitter is aware of the situation at the receiver it cannot be guaranteed there will be no effect on the higher priority transmission. Similarly the lower priority UE may miss the higher priority reservation and hence continue to transmit at the original power on the overlapping resources.

In order to mitigate effects on the higher priority transmission if the higher priority UE detects a lower priority reservation on the overlapping resources it may adjust its transmission parameters to reduce the risk of degradation. The UE may thus choose a higher aggregation level for the 1^{st} stage SCI, use more resources for the 2^{nd} stage SCI, and/or select a different MCS for the PSSCH shared channel transmission. The UE may also vary the number and arrangement of DMRS in the shared channel transmission. For example, different DMRS patterns may be defined for use when there are overlapping transmissions. Similarly, the DMRS for PSCCH may be offset in frequency such that they do not overlap.

In a further option, used together or separately with the preceding options, the higher priority UE may be permitted to transmit with a higher power when its selected resources were previously reserved for a lower priority transmission. The power adjustment may be made according to the same methods and principles discussed above for reducing the lower priority transmission power, but in the opposite direction (i.e. increase rather than decrease).

The behaviour of a UE with transmission resources reserved for a lower priority transmission which detects an overlapping higher priority reservation may be defined by the relevant resource pool configuration. This may configure the relevant UEs to prevent pre-emption of reservations for the resource pool. If a UE detects an overlapping reservation in this resource pool it can ignore that reservation as planned because it can be assumed the reservation is a result of errors (for example channel variations) since pre-emption is not permitted. The resource pool configuration may stop transmission by the lower priority UE whenever an SL RSRP value for a reservation of overlapping resources for a higher priority transmission exceeds a threshold. As discussed above, the lower priority UE may be permitted to transmit at a lower power, and/or the higher priority UE may be permitted to transmit at a higher power. The options and applicable parameters may be combined and varied as determined most appropriate for the particular resource pool. For example, the resource pool configuration may permit the lower priority UE to either stop transmission or to transmit at a lower power. The particular UE can then decide which action to take depending on the particular circumstances of a pre-emption. Similarly the resource pool configuration may specify the mechanism for selecting which action the UE should take; for example as a function of the difference in priority between the two transmissions, or the power difference between the RSRP measurement for the higher priority transmission and the SL RSRP threshold.

In an example configuration, a lower priority UE detecting a higher priority transmission with overlapping resources may be permitted to transmit at a lower power, or to cancel the transmission and not transmit. The selection of an option for a particular pre-emption is based on the RSRP of the overlapping transmission from the higher priority UE.

As shown in the following table two thresholds for RSRP are defined. Values between Th1 and Th2 indicate that the lower priority UE should transmit at reduced power, while an RSRP above Th2 indicates that the lower priority UE should not transmit:—

| RSRP | Action |
|---|---|
| Th1 < Received | Transmit with reduced power |
| RSRP <= Th2 | on overlapping resource |
| Th2 < Received | Apply pre-emption |
| RSRP | (Do not transmit) |

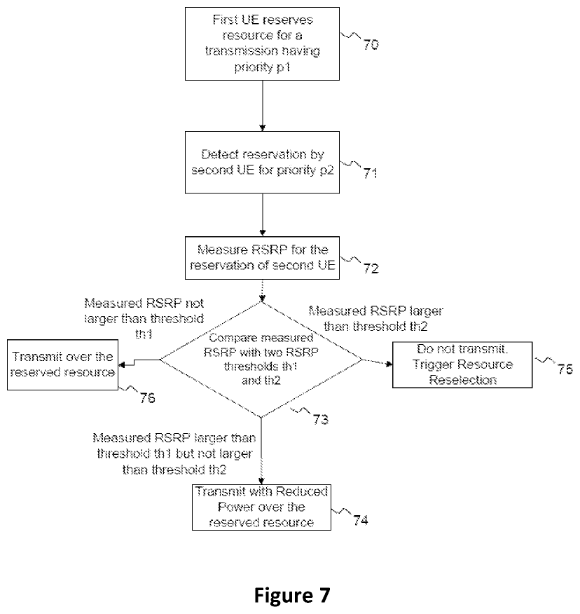

This process is shown graphically in FIG. 7 in which steps 70-72 correspond to steps 60-62 previously described. Step 73 is comparable to previous step 60, but the measured RSRP is compared to the two thresholds Th1 and Th2. The UE then performs one of steps 74-76 depending on the result of the comparison. The power reduction of step 74 may be performed according to the principles described above with reference to FIG. 6.

In this example two thresholds are utilised, but additional thresholds could be configured, for example to utilise power reductions which vary at each threshold.

This example configuration allows transmission by both UEs where there is a reasonable prospect of the lower priority UEs transmission being successful without degrading the higher priority UE's transmission. However, where the higher priority transmission is too high and hence interference is likely to prevent a successful transmission by the lower priority UE, transmission is stopped.

In general a UE should only reserve overlapping transmission resources if its priority is higher than the earlier reservation of those resources. However, UEs using sidelink transmissions are highly mobile, and channel qualities may vary rapidly. It is therefore possible that a UE will reserve overlapping resources based on a lower or equal priority than an earlier reservation, due to not being aware of the earlier reservation.

If the UE with the higher (and earlier) reservation for the overlapping resources detects this later reservation it has a choice how to behave. If the lower priority UE's transmission is sufficiently low, for example below a pre-configured threshold, there may be negligible effect on the higher priority transmission and both transmissions can continue as planned. The higher priority UE may thus estimate the RSRP from the lower priority UE's (later) reservation transmission and compare it to an SL RSRP threshold. The threshold is selected at a value above which it is anticipated transmissions on overlapping resources will degrade the higher priority transmission.

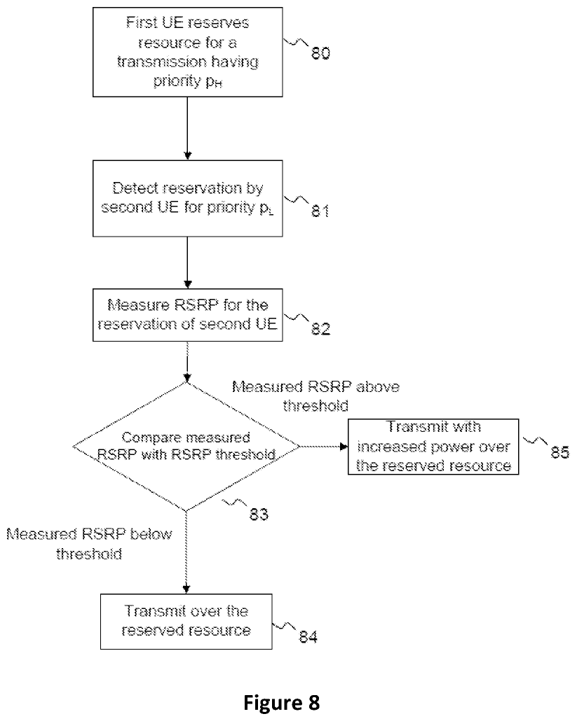

If the RSRP of the later reservation (with a lower priority) is above the SL RSRP threshold, the higher priority UE may be permitted to transmit with an increased transmission power on the overlapping resources. This improves the probability that the transmission will be successfully decoded. For example, the transmission power may be increased by a predefined value, such as 3 dB. The actual increase may be defined by UE capability, in particular its maximum transmission power and the originally intended transmission power. This process is shown in FIG. 8. The steps are comparable to those described earlier, except at step 80 the first UE has a higher priority p_{H}, and the second UE at step 81 has a lower priority p_{L}. If at step 83 the measured RSRP is above the threshold the first UE (priority p_{H}) transmits with an increased transmission power.

Similar to the above disclosure, multiple values for the power increase may be defined such that the UE can select an appropriate value. The values may be defined in the resource pool configuration. For example, the appropriate value may be selected dependent on the difference between the measured RSRP and the SL RSRP threshold. As noted above, if the UE is not capable of the initially selected increase, a different value may be selected that can be performed by the UE.

The values for possible power increases may be defining in a table mapping values to ranges for the difference between the measured RSRP and the SL RSRP threshold.

It is possible that the higher priority UE may decide that increasing transmission power is not possible (for example it cannot provide the higher power) or that even with an increase in power transmission will not be successful. In such a case the higher priority UE may decide not to make the transmission and to reselect resources. Alternatively, the higher priority UE may adapt the transmission parameters (for example MCS) in an effort to enable a successful transmission, in addition to a possible increase of transmission power.

In one example, the pre-configuration tells the higher priority UE its behaviour upon detecting a lower priority UE with overlapping resources. Two different RSRP thresholds may be configured. If the estimated RSRP of the lower priority transmission is not larger than the first threshold, the higher priority UE transmits with nominal power, ignoring the presence of lower priority transmission. If the estimated RSRP is larger than the first threshold but not larger than the second threshold, it transmits with boosted power. If the estimated RSRP is even larger than the second threshold, it does not transmit and triggers resource re-selection to transmit its transmission.

If only a part of reserved resources overlap, the higher priority UE may transmit on the non-overlapping part of its reservation. To facilitate this the UE will indicate the changes to resources in its relevant SCI transmission. The SCI may thus indicate a subset of the originally reserved resources. The transmission parameters may also need to updated based on the reduced resources to improve the prospects of successful detection. For example, the 2^{nd} stage SCI format may be altered, the MCS of the shared channel transmission adjusted, the number of DMRS symbols and specific DMRS pattern may be changed, and/or the number of DMRS ports may need to be suitably selected for the transmission.

The overlapping portion may include the control information (1^{st} stage SCI or the 2^{nd} stage SCI) or the DMRS symbols which would make decoding the non-overlapping part of the transmission hard. In such an overlap it may be preferable to cancel the transmission and reselect new resources.

In all examples herein reselection of transmission resources after detection of an overlap can be conducted according to the general (re-)selection process for Mode 2 sidelink resource allocation.

In general the term “pre-empt” is used to indicate that overlapping resources are used by the higher priority UE and the lower priority UE does not transmit. However, in certain contexts, as will be clear from the relevant text, the term may be used to indicate that a higher priority UE reserves overlapping resources but the lower priority UE still makes a transmission.

As will be appreciated, the techniques described herein may be applicable to all types of sidelink transmission, and in particular to unicast, groupcast and broadcast transmissions.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally 45 referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ or “including” does not exclude the presence of other elements.

1. A method of scheduling sidelink transmissions between mobile stations in a cellular communications network, the method comprising the steps of
at a first mobile station transmitting a first reservation with a first priority for first reserved transmission resources;
at the first mobile station detecting a second reservation by a second mobile station for second reserved transmission resources which overlap with the first reserved transmission resources;
at the first mobile station measuring the RSRP of the second reservation;
at the first mobile station comparing the measured RSRP to a first predefined threshold; and
if the measured RSRP is greater than the first predefined threshold, at the first mobile station considering the first reserved transmission resources as pre-empted, cancelling the transmission on the first reserved transmission resources, and initiating re-selection of transmission resources to replace the first reserved transmission resources using a second priority which is higher than the first priority.

2. The method according to claim 1, wherein if the re-selected transmission resources are pre-empted, at the first mobile station performing a further re-selection with a priority that is higher than the second priority.

3. The method according to claim 1, wherein the priority is increased by the same amount at each re-selection or by a different amount at each re-selection.

4. (canceled)

5. The method according to claim 1, further comprising at a third mobile station receiving a transmission on the re-selected transmission resources with an increased priority, and reducing that increased priority to the original value.

6. The method according to claim 1, wherein the increase in priority is dependent on the mobile station's configuration or the resource pool of the transmission resources.

7-8. (canceled)

9. A method of scheduling sidelink transmissions between mobile stations in a cellular communications network, the method comprising the steps of
at a first mobile station transmitting a first reservation with a first priority for first reserved transmission resources;
at the first mobile station detecting a second reservation by a second mobile station for second reserved transmission resources which overlap with the first reserved transmission resources;
at the first mobile station measuring the RSRP of the second reservation;
at the first mobile station comparing the measured RSRP for the second reservation to a threshold, wherein the threshold is dependent on whether the first reservation is a new reservation or a re-selection following pre-emption of a previous reservation; and
if the measured RSRP is greater than the threshold, at the first mobile station considering the first reserved transmission resources as pre-empted, cancelling the transmission on the first reserved transmission resources, and initiating re-selection of transmission resources to replace the first reserved transmission resources using the same priority as the first reservation.

10. The method according to claim 9, wherein the threshold is dependent on the number of times the planned transmission has re-selected.

11. The method according to claim 9, wherein the threshold is increased by the same amount for each previous re-selection or by a different amount at each re-selection.

12-13. (canceled)

14. The method according to claim 9, wherein the threshold is dependent on a configuration of the mobile station or a configuration of the resource pool of the reserved transmission resources.

15. (canceled)

16. A method of scheduling sidelink transmissions between mobile stations in a cellular communications network, the method comprising the steps of
at a first mobile station transmitting a first reservation with a first priority for first reserved transmission resources;
at the first mobile station detecting a second reservation by a second mobile station for second reserved transmission resources which overlap with the first reserved transmission resources;
at the first mobile station measuring the RSRP for the second reservation;
at the first mobile station comparing the measured RSRP for the second reservation to a threshold, and
at the first mobile station transmitting on the first reserved transmission resources, wherein the transmission power is reduced dependent on the comparison of the measured RSRP to the threshold.

17. The method according to claim 16, wherein the transmission power is reduced by the difference between the threshold and the measured RSRP or based on the difference between the threshold and the measured RSRP.

18. (canceled)

19. The method according to claim 16, wherein the reduction is dependent on a configuration of the mobile station or a configuration of the resource pool of the reserved transmission resources.

20. (canceled)

21. The method according to claim 16, wherein the threshold is dependent on whether the first reservation is a new reservation or a re-selection.

22-23. (canceled)

24. The method according to claim 16, wherein when the transmission power is reduced other transmission parameters are modified for transmissions on the first reserved transmission resources.

25. The method according to claim 24, wherein the modulation coding scheme is adjusted, the code rate is increased, or a higher aggregation level is utilised.

26. The method according to claim 24, wherein the modulation format of a second stage SCI transmitted in the first reserved transmission resources is adjusted when the transmission power is reduced.

27. The method according to claim 16, wherein the position of reference symbols in the transmission on the first reserved transmission resources is adjusted to avoid a collision with reference symbols in the second reserved transmission resources.

28. The method according to claim 16, wherein the position of a sidelink control information element in the transmission on the first reserved transmission resources is adjusted to avoid a collision with a sidelink control information element SCI in the second reserved transmission resources.

29. The method according to claim 16, wherein if the difference between the measured RSRP and the threshold is greater than a second threshold, cancelling the first reservation and performing a re-selection.

30. The method according to claim 16, wherein the transmission power on the first reserved transmission resources is increased if the priority of the second reservation is not higher than the first priority.

31-35. (canceled)
